(19) United States
(12) Patent Application Publication
(10) Pub. No.: US 2010/0228367 A1
(43) Pub. Date: Sep. 9, 2010

(54) DATA CARD FOR A COMPUTER SYSTEM AND RELATED COMPUTER SYSTEM

(76) Inventors: Chu-Chia Tsai, Taipei Hsien (TW); Yi-Wei Tau, Taipei Hsien (TW); Shih-Heng Chen, Taipei Hsien (TW); Tsun-Chih Yang, Taipei Hsien (TW); Chang-Chih Han, Taipei Hsien (TW); Pin-Hsien Su, Taipei Hsien (TW); Wen-Chin Wu, Taipei Hsien (TW); Sung-Yu Hsieh, Taipei Hsien (TW); Hung-Yang Hsu, Taipei Hsien (TW); Chia-Hsien Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/614,447

(22) Filed: Nov. 9, 2009

(30) Foreign Application Priority Data
Mar. 6, 2009 (TW) 098107392

(51) Int. Cl. G06F 17/00; H04M 1/00

(52) U.S. Cl. 700/94; 455/550.1

(57) ABSTRACT

A data card for a computer system capable of providing a loudspeaker mode for a mobile phone call is disclosed. The data card includes an antenna, an RF module, a first signal processing unit for processing a baseband signal for generating a first analog audio output signal corresponding to audio data played by a speaker when the computer system operates in the loudspeaker mode, a second signal processing unit, a transmission interface for outputting a first digital audio output signal corresponding to the audio data to the computer system, wherein the first digital audio output signal is generated according to the first analog audio output signal through an encoding process, a microphone device, and an audio codec for performing the encoding process on the first analog audio output signal in order to generate the first digital audio output signal.

### BACKGROUND OF THE INVENTION

1. Field of the Invention

The present invention relates to a data card for a computer system and related computer system, and more particularly, to a data card supporting multiple talk modes for a computer system and related computer system.

2. Description of the Prior Art

Mobile internet devices, which integrate communication functions of a mobile phone with high computing power of a computer, are produced for growing internet services. As the mobile internet devices have yet to become ubiquitous, a user typically plugs a data card into a notebook computer to provide mobile internet functions.

In general, data cards connect with laptop computers through a transmission interface belonging to a bus standard, such as PCMCIA, PCI Express, or Universal Serial Bus (USB), and the data card usually supports a 2G (or better) mobile communications standard for providing mobile phone functions. Please refer to FIG. 1, which is a block diagram of a data card 10 according to the prior art. The data card 10 comprises an antenna 100, a radio frequency (RF) module 102, a signal processor 104, a headphone jack 106 for connecting a headphone/microphone, and a USB interface 108. The antenna 100 is utilized for transmitting and receiving RF signals. The RF module 102 is coupled to the antenna 100, and is utilized for performing a modulation process on baseband signals, and performing a demodulation process on RF signals. The signal processor 104 is coupled to the RF module 102, and is utilized for performing an encoding process on baseband signals, and performing a decoding process on analog audio signals. The headphone jack 106 is coupled to the signal processor 104 and a headphone/microphone set 12 with a built-in microphone. The headphone/microphone set 12 is used for receiving human voices and background voices through the mechanical structure of a microphone and converting these voices into an electrical signal, such as an analog audio input signal SA_{IN}. The analog audio input signal SA_{IN} is transmitted to the signal processor 104 through the headphone jack 106, and is processed by the signal processor 104. Meanwhile, the signal processor 104 generates an analog audio output signal SA_{OUT}. The analog audio output signal SA_{OUT} is transmitted to the headphone/microphone set 12 through the headphone jack 106, and is played.

The data card 10 connects with a computer through the USB interface 108 so as to provide internet functions and mobile communication functions. A user can use the computer connected to the data card 10 to make a mobile phone call. However, the only audio signal interface of the data card 10 is the headphone jack 106, and the user cannot make a mobile phone call without using the headphone/microphone set 12. Talk modes provided by the computer connected to the data card 10 do not include a loudspeaker mode, also called a hands-free mode. Therefore, the conventional data card is not flexible in its use.

### SUMMARY OF THE INVENTION

It is therefore a primary objective of the claimed invention to provide a data card supporting multiple talk modes for a computer system and related computer system.

The present invention discloses a data card for a computer system capable of providing a loudspeaker mode for a mobile phone call. The data card comprises an antenna for transmitting a first RF signal and receiving a second RF signal, an RF module coupled to the antenna for modulating a first baseband signal for generating the first RF signal, for demodulating the second RF signal, and for generating a second baseband signal, a first signal processing unit coupled to the RF module for processing the second baseband signal for generating a first analog audio output signal corresponding to audio data played by a speaker when the computer system operates in the loudspeaker mode, a second signal processing unit coupled to the RF module for receiving a first analog audio input signal and processing the first analog audio input signal to generate the first baseband signal, a transmission interface for outputting a first digital audio output signal corresponding to the audio data to the computer system, wherein the first digital audio output signal is generated according to the first analog audio output signal through an encoding process, a microphone device coupled to the second signal processing unit for outputting the first analog audio input signal to the second signal processing unit, and an audio codec coupled to the first signal processing unit, the transmission interface, and the microphone device, for performing the encoding process on the first analog audio output signal in order to generate the first digital audio output signal, and outputting the first digital audio output signal to the transmission interface.

The present invention further discloses a computer system capable of providing a loudspeaker mode for a mobile phone call. The computer system comprises a host device for implementing the computer system, including a speaker for playing audio data when the computer system operates in the loudspeaker mode, and a data card for implementing a mobile internet function. The data card comprises an antenna for transmitting a first RF signal and receiving a second RF signal, an RF module coupled to the antenna for modulating a first baseband signal, for generating the first RF signal, for demodulating the second RF signal, and for generating a second baseband signal, a first signal processing unit coupled to the RF module for processing the second baseband signal for generating a first analog audio output signal corresponding to audio data played by a speaker when the computer system operates in the loudspeaker mode, a second signal processing unit coupled to the RF module for receiving a first analog audio input signal and processing the first analog audio input signal to generate the first baseband signal, a transmission interface coupled to the host device for outputting a first digital audio output signal corresponding to the audio data to the host device, wherein the first digital audio output signal is generated according to the first analog audio output signal through an encoding process, a microphone device coupled to the second signal processing unit for outputting the first analog audio input signal to the second signal processing unit, and an audio codec coupled to the first signal processing unit, the transmission interface, and the microphone device, for performing the encoding process on the first analog audio output signal in order to generate the first digital audio output signal, and outputting the first digital audio output signal to the transmission interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data card according to the prior art.

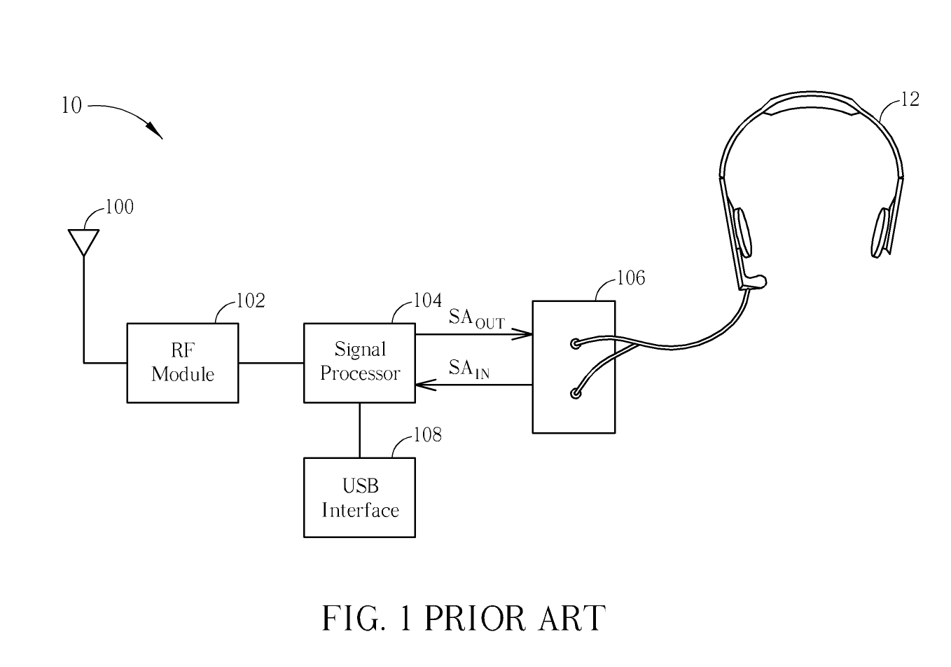

FIG. 2 is a block diagram of a data card according to an embodiment of the present invention.

FIG. 3 is a block diagram of a computer system according to an embodiment of the present invention.

FIG. 4 is a block diagram illustrating audio signal paths in the computer system in FIG. 3 when the computer system operates in a loudspeaker mode.

FIG. 5 is a block diagram illustrating audio signal paths in the computer system in FIG. 3 when the computer system operates in a VoIP mode.

FIG. 6 is a block diagram of a data card according to an embodiment of the present invention.

### DETAILED DESCRIPTION

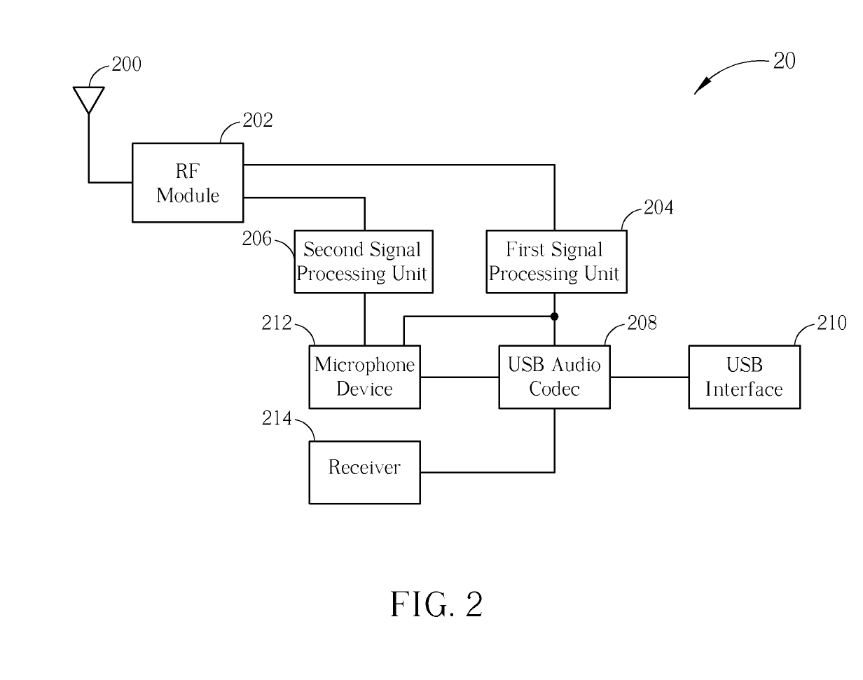

Please refer to FIG. 2, which is a block diagram of a data card 20 according to an embodiment of the present invention. The data card 20 is utilized for a computer system, for providing mobile internet functions. The data card 20 comprises an antenna 200, an RF module 202, a first signal processing unit 204, a second signal processing unit 206, a USB audio codec 208, a USB interface 210, a microphone device 212, a receiver 214, and a headphone jack 216 (which is not shown in FIG. 2) used for a headphone/microphone set. The data card 20 connects with a host device of the computer system through the USB interface 210. Note that the data card according to the present invention aims to control the computer system to provide multiple talk modes, and thus the coupling relationships and signal paths shown in the figures are described with respect to audio signals. The USB interface 210 is one embodiment of the transmission interface in the embodiment, and another embodiment will be given later.

In the data card 20, the antenna 200 is utilized for transmitting RF signals generated by the RF module 202 and receiving RF signals from the air. The RF module 202 is coupled to the antenna 200, and is utilized for performing a demodulation process on the RF signals received from the antenna 200 for generating baseband signals to be processed, and performing a modulation process on baseband signals generated by the second signal processing unit 206 for generating RF signals to be transmitted. The first signal processing unit 204 is coupled to the RF module 202, the USB audio codec 208 and the microphone device 212. The second signal processing unit 206 is coupled to the RF module 202 and the microphone device 212. The first signal processing unit 204 and the second signal processing unit 206 can be integrated into one signal processing unit in another embodiment. The USB audio codec 208 is coupled to the first signal processing unit 204, the USB interface 210, the microphone device 212, and the receiver 214. The USB interface 210 is coupled to the USB audio codec 208 and the host device. The microphone device 212 is an array microphone, and is utilized for receiving audio data. The receiver 214 is utilized for playing audio data. The phone jack 216 is utilized for connecting a headphone/microphone set used for receiving and playing audio data.

The data card 20 does not only comprise the headphone jack, but also comprises the USB audio codec, the microphone device, and the receiver, which are not present in a conventional data card. Through the data card 20, a loudspeaker mode and a VoIP mode are provided by the computer system. Each unit in the data card 20 has different operations in different talk modes, which are described as follows.

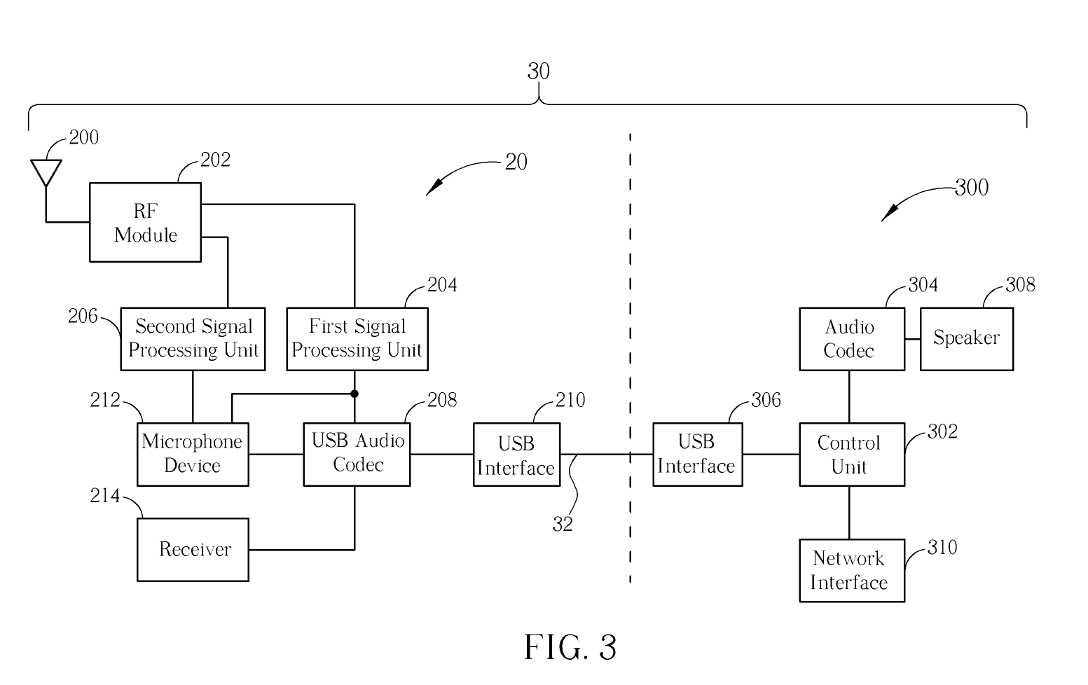

Please refer to FIG. 3, which is a block diagram of a computer system 30 according to an embodiment of the present invention. The computer system 30 comprises a host device 300 and the data card 20 shown in FIG. 2. The host device 300 is a core device of the computer system 30 for computing, storing, and controlling data input/output. The data card 20 connects with the host device 300 through a USB cable 32, and is utilized for providing a mobile internet function and a mobile phone function. The host device 300 comprises a control unit 302, an audio codec 304, a USB interface 306, a speaker 308, and a network interface 310. The control unit 302 is a south-bridge integrated circuit coupled to the audio codec 304, the USB interface 306 and the network interface 310. The control unit 302 is utilized for controlling output/input functions. The audio codec 304 is utilized for performing encoding and decoding processes on digital serial data and analog audio signals respectively, which is well-known to those skilled in the art and is not given here. The speaker 308 is coupled to the audio codec 304. The network interface 310 is coupled to the control unit 302, and is utilized for connecting with the internet; the network interface 310 can be a wired or a wireless transmission interface, such as an Ethernet controller or a WiFi transmission module. Please note that the aforementioned units are parts of the host device 300 which are associated with the present invention; other parts of the host device 300 not related to the present invention are not described herein.

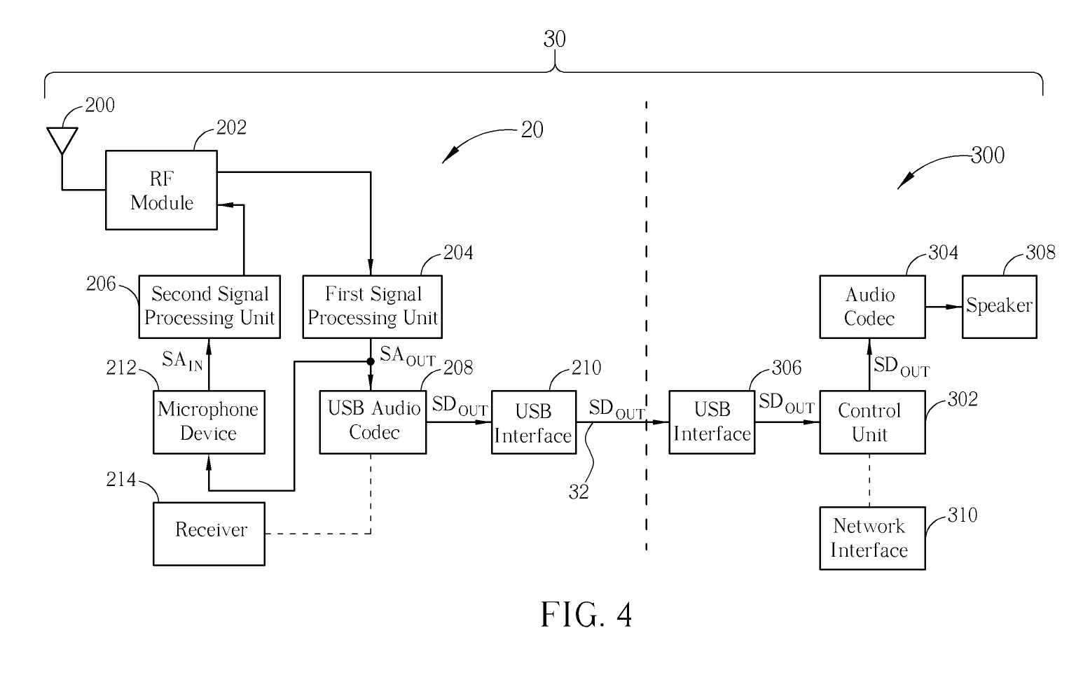

Operations of the data card 20 and the host device 300 are given in detail with respect to the two different talk modes: a loudspeaker mode and a VoIP mode. Please refer to FIG. 4, which is a block diagram illustrating audio signal paths in the computer system 30 in FIG. 3 when the computer system 30 operates in the loudspeaker mode. A user A using the computer system 30 is assumed to have a mobile phone call in the loudspeaker mode with a user B through the data card 20; that is, audio data including human voices and background voices in the user B side is played by the speaker 308.

Audio signal paths of the loudspeaker mode are described as follows. With respect to a receiving path for the user A, a communication device used by the user B converts audio data at the user B side into an RF signal transmitted to the air. After the antenna 200 of the data card 20 receives the RF signal transmitted from the user B, the RF module 202 then demodulates the RF signal and generates a baseband signal. The first signal processing unit 204 performs a signal process on the baseband signal for generating an analog audio output signal SA_{OUT} and outputting the analog audio output signal SA_{OUT} to the USB audio codec 208. The USB audio codec 208 performs an encoding process on the analog audio output signal SA_{OUT} and thereby generates a digital audio output signal SD_{OUT} and outputs the digital audio output signal SD_{OUT} to the USB interface 210. The USB interface 210 outputs the digital audio output signal SD_{OUT} to the host device 300. The USB interface 306 receives the digital audio output signal SD_{OUT} and outputs the digital audio output signal SD_{OUT} to the control unit 302. The control unit 302 transmits the digital audio output signal SD_{OUT} to the audio codec 304. The audio codec 304 performs a decoding process on the digital audio output signal SD_{OUT}, for generating audio data to be played, which sounds the same as the audio data at the user B side. The speaker 308 plays the audio data generated by the audio codec 304, and therefore the user A hears the voice of the user B. For the receiving path, the analog audio output signal SA_{OUT} and the digital audio output signal SD_{OUT} are signal representations of the audio data at the user B side in analog or digital format.

On the other hand, with respect to a transmitting path for the user A, the microphone device 212 of the data card 20 receives audio data at the user A side including voices of the user A and background voices, converts the audio data into an analog audio input signal SA_{IN} through the mechanical structure of the microphone device 212, and outputs the analog audio input signal SA_{IN} to the second signal processing unit 206. The second signal processing unit 206 performs a signal process on the analog audio input signal SA_{IN} for generating a baseband signal to be transmitted. The RF module 202 converts the baseband signal into an RF signal transmitted by the antenna 200.

In the loudspeaker mode, the microphone device 212 not only receives the voice of the user A but also receives the background voices at the user A side, including the audio data played by the speaker 308, which is the voice of the user B. In this situation, what the user B hears may include the voice of the user A and even the voice of the user B itself. This is a so-called echo effect. In the embodiment, the USB audio codec 208 also outputs the analog audio output signal SA_{OUT} to the microphone device 212, so that a filtering circuit inside the microphone device 212 can perform echo cancellation on the analog audio output signal SA_{OUT}. Echo cancellation means when the microphone device 212 converts audio data of the user A into the analog audio input signal SA_{IN}, the microphone device 212 excludes the audio data of the user B (which corresponds to the analog audio output signal SA_{OUT}) included in the audio data of the user A, by using the filtering circuit. As a result, the interference on the analog audio input signal SA_{IN} caused by the analog audio output signal SA_{OUT} can be eliminated as much as possible. Then, when the user A has a phone conversation with the user B, the analog audio input signal SA_{IN} is processed by the second signal processing unit 206 and the RF module 202, and finally is transmitted to the communication device of the user B. By the echo cancellation function provided by the microphone device 212, the user B will not hear his/her own voice, so that the echo problem is improved.

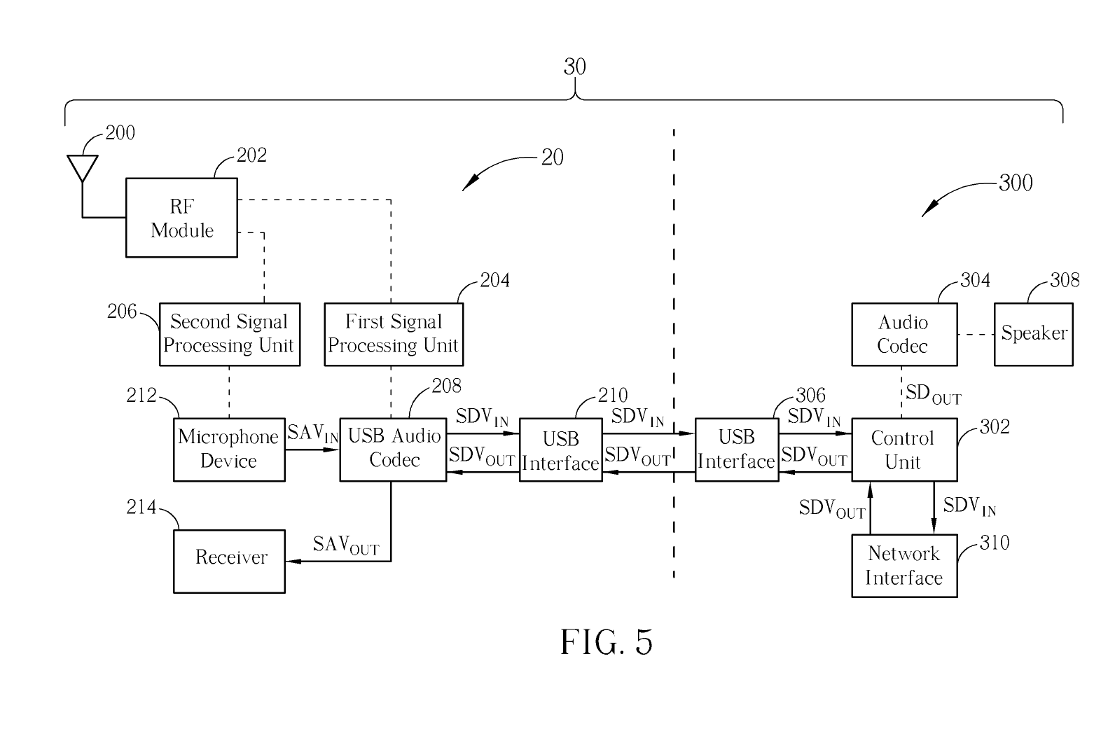

Please refer to FIG. 5, which is a block diagram illustrating audio signal paths in the computer system 30 in FIG. 3 when the computer system 30 operates in the VoIP mode. In the VoIP mode, the computer system 30 connects with the internet through the network interface 310, and therefore the user A can make a VoIP phone call to another user. Note that the data card 20 comprises the microphone device 212 and the receiver 214, and connects with the host device 300 through the USB cable 32, so that the user can utilize the data card 20 as a hand-held VoIP phone set. With respect to the receiving path, when the user uses the computer system 30 to make a VoIP phone call, the network interface 310 receives signals from the internet and converts the received signals to a digital audio output signal SDV_{OUT}. The digital audio output signal SDV_{OUT} is transmitted through the control unit 302, USB interface 306, the USB interface 210, finally to the USB audio codec 208. The USB audio codec 208 performs a decoding process on the digital audio output signal SDV_{OUT} and generates an analog audio output signal SAV_{OUT}, which is played by the receiver 214. Meanwhile, with respect to the transmitting path, the microphone device 212 receives voices of the user and converts the voices to an analog audio input signal SAV_{IN} outputted to the USB audio codec 208. The USB audio codec 208 performs an encoding process on the analog audio input signal SAV_{IN} and generates a digital audio input signal SDV_{IN}. The digital audio input signal SDV_{IN} is transmitted through the USB interface 210, the USB interface 306, the control unit 302, and finally to the network interface 310. The network interface 310 transmits the digital audio input signal SDV_{IN} to the Internet.

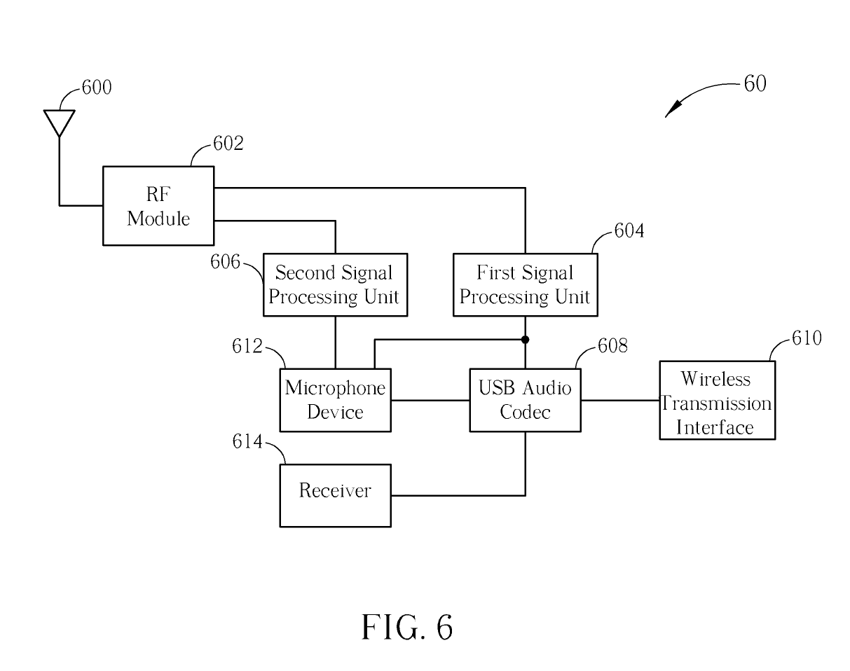

Note that, the data card 20 and the computer system 30 are embodiments of the present invention, and those skilled in the art can make alterations and modifications accordingly. Please refer to FIG. 6, which is a block diagram of a data card 60 according to an embodiment of the present invention. The data card 60 comprises an antenna 600, an RF module 602, a first signal processing unit 604, a second signal processing unit 606, a USB audio codec 608, a wireless transmission interface 610, a microphone device 612, and a receiver 614. The data card 60 is similar to the data card 20 in FIG. 2 and is not repeated herein. Note that the transmission interface of the data card 60 is different from that of the data card 20. The data card 20 uses the wired USB interface 210 to connect with the host device, whereas the data card 60 uses the wireless transmission interface 610 to connect with the host device. The wireless transmission interface 610 can be an ultra wideband (UWB) transmission module or a WiFi transmission module. The wireless transmission interface 610 is utilized for performing a modulation process on a digital audio signal, for generating an RF signal, and performing a demodulation process on a received RF signal, for generating a digital audio signal.

When the data card 60 connected to a host device operates in a loudspeaker mode or a VoIP mode, the receiving and transmitting paths are similar to those shown in FIG. 4 and FIG. 5, and are not repeated herein. The host device connected with the data card 60 also includes a wireless transmission interface for performing modulation/demodulation on signals. In other words, the transmission interface used in the data card according to the present invention can be a USB interface and can be a wireless transmission interface of a proper wireless communication standard. In another embodiment, the data card may provide more than one transmission interface, or may provide both a wired transmission interface and a wireless transmission interface; the user can select a proper transmission interface to be used among the provided transmission interfaces.

The data card according to the present invention aims to transmit audio signals to the host device and receive audio signals from the host device in the loudspeaker mode or in the VoIP mode. Note that the USB audio codec 208 is one of embodiments of the present invention and accompanies the USB interface 210. When the transmission interfaces of the data card and the host device are not USB interfaces, e.g. the data card uses a wireless transmission interface, the data card can use a general audio codec instead of the USB audio codec.

In the prior art, the user receives a mobile phone call by a conventional data card only by using the external headphone/microphone set; the loudspeaker mode is not supported. In order to receive a VoIP phone call, the user has to use an external VoIP phone set connected to the computer system. In comparison, through the data card according to the present invention, the user receives a mobile phone call and can select the loudspeaker mode as the talk mode. In addition, the data card according to the present invention can be used as a VoIP phone set, and therefore the external phone set for the host device is not required.

In conclusion, by using the data card according to the present invention, the computer system provides a loudspeaker mode, so that the user has more choices of talk mode. In addition, the data card according to the present invention can be used as a VoIP phone set when the computer system operates in a VoIP mode; no additional VoIP phone set is required. Therefore, mobile internet and mobile communication functions of the computer system are greatly improved.

Those skilled in the art will readily observe that numerous modifications and alterations of the device and method may be made while retaining the teachings of the invention.

What is claimed is:

1. A data card for a computer system capable of providing a loudspeaker mode for a mobile phone call, the data card comprising:
an antenna for transmitting a first radio frequency (RF) signal and receiving a second RF signal;
an RF module coupled to the antenna for modulating a first baseband signal, for generating the first RF signal, for demodulating the second RF signal, and for generating a second baseband signal;
a first signal processing unit coupled to the RF module for processing the second baseband signal for generating a first analog audio output signal corresponding to audio data played by a speaker when the computer system operates in the loudspeaker mode;
a second signal processing unit coupled to the RF module for receiving a first analog audio input signal and processing the first analog audio input signal to generate the first baseband signal;
a transmission interface for outputting a first digital audio output signal corresponding to the audio data to the computer system, wherein the first digital audio output signal is generated according to the first analog audio output signal through an encoding process;
a microphone device coupled to the second signal processing unit for outputting the first analog audio input signal to the second signal processing unit; and
an audio coder/decoder (codec) coupled to the first signal processing unit, the transmission interface, and the microphone device, for performing the encoding process on the first analog audio output signal in order to generate the first digital audio output signal, and outputting the first digital audio output signal to the transmission interface.

2. The data card of claim 1, wherein the first digital audio output signal is decoded by a host device of the computer system, for generating the audio data.

3. The data card of claim 1 further comprising:
a receiver coupled to the audio codec for playing a second analog audio output signal when the computer system operates in a VoIP mode.

4. The data card of claim 1, wherein the transmission interface is further utilized for receiving a second digital audio output signal from a host device of the computer system and outputting a second digital audio input signal to the host device when the computer system operates in a VoIP mode.

5. The data card of claim 1, wherein the audio codec is further utilized for receiving a second digital audio output signal from the transmission interface, and performing a decoding process on the second digital audio output signal for generating a second analog audio output signal outputted to a receiver of the data card when the computer system operates in a VoIP mode.

6. The data card of claim 1, wherein the audio codec is further utilized for receiving a second analog audio input signal outputted from the microphone device, and performing the encoding process on the second analog audio input signal for generating a second digital audio input signal outputted the transmission interface when the computer system operates in a VoIP mode.

7. The data card of claim 1, wherein the first signal processing unit is further utilized for outputting the first analog audio output signal to the microphone device.

8. The data card of claim 1, wherein the audio codec is a universal serial bus (USB) audio codec.

9. The data card of claim 1, wherein the transmission interface is a universal serial bus (USB) interface for wiredly transmitting the first digital audio output signal.

10. The data card of claim 1, wherein the transmission interface is an ultra wideband (UWB) transmission module for modulating the first digital audio output signal to generate an RF signal.

11. The data card of claim 1, wherein the transmission interface is a WiFi transmission module for modulating the first digital audio output signal to generate an RF signal.

12. A computer system capable of providing a loudspeaker mode for a mobile phone call, the computer system comprising:
a host device for implementing the computer system, including a speaker for playing audio data when the computer system operates in the loudspeaker mode; and
a data card for implementing a mobile internet function, the data card comprising:
an antenna for transmitting a first radio frequency (RF) signal and receiving a second RF signal;
an RF module coupled to the antenna for modulating a first baseband signal, for generating the first RF signal, for demodulating the second RF signal, and for generating a second baseband signal;
a first signal processing unit coupled to the RF module for processing the second baseband signal for generating a first analog audio output signal corresponding to audio data;
a second signal processing unit coupled to the RF module for receiving a first analog audio input signal and processing the first analog audio input signal to generate the first baseband signal;
a transmission interface coupled to the host device for outputting a first digital audio output signal corresponding to the audio data to the host device, wherein the first digital audio output signal is generated according to the first analog audio output signal through an encoding process;
a microphone device coupled to the second signal processing unit for outputting the first analog audio input signal to the second signal processing unit; and
an audio coder/decoder (codec) coupled to the first signal processing unit, the transmission interface, and the microphone device, for performing the encoding process on the first analog audio output signal in order to generate the first digital audio output signal, and outputting the first digital audio output signal to the transmission interface.

13. The computer system of claim 12, wherein the first digital audio output signal is decoded by the host device, for generating the audio data.

14. The computer system of claim 12 further comprising:
a receiver coupled to the audio codec for playing a second analog audio output signal when the computer system operates in a VoIP mode.

15. The computer system of claim 12, wherein the transmission interface is further utilized for receiving a second digital audio output signal from the host device and outputting a second digital audio input signal to the host device when the computer system operates in a VoIP mode.

16. The computer system of claim 12, wherein the audio codec is further utilized for receiving a second digital audio output signal from the transmission interface, and performing a decoding process on the second digital audio output signal to generate a second analog audio output signal outputted to a receiver of the data card when the computer system operates in a VoIP mode.

17. The computer system of claim 12, wherein the audio codec is further utilized for receiving a second analog audio input signal outputted from the microphone device, and performing the encoding process on the second analog audio input signal to generate a second digital audio input signal outputted to the transmission interface when the computer system operates in a VoIP mode.

18. The computer system of claim 12, wherein the first signal processing unit is further utilized for outputting the first analog audio output signal to the microphone device.

19. The computer system of claim 12, wherein the audio codec is a universal serial bus (USB) audio codec.

20. The computer system of claim 12, wherein the transmission interface is a universal serial bus (USB) interface for wiredly transmitting the first digital audio output signal.

21. The computer system of claim 12, wherein the transmission interface is an ultra wideband (UWB) transmission module for modulating the first digital audio output signal to generate an RF signal, and transmitting the RF signal to the host device.

22. The computer system of claim 12, wherein the transmission interface is a WiFi transmission module for modulating the first digital audio output signal to generate an RF signal, and transmitting the RF signal to the host device.
